(19) United States
(12) Patent Application Publication
(10) Pub. No.: US 2025/0045339 A1
(43) Pub. Date: Feb. 6, 2025

(54) METHOD, APPARATUS, DEVICE AND MEDIUM FOR SEARCH

(71) Applicant: Beijing Zitiao Network Technology Co., Ltd., Haidian District (CN)

(72) Inventors: Mengna Tong, Beijing (CN); Zhigao Chen, Beijing (CN)

(21) Appl. No.: 18/677,118

(22) Filed: May 29, 2024

(30) Foreign Application Priority Data
Jul. 31, 2023 (CN) 202310952510.8

(51) Int. Cl. G06F 16/9538; G06F 16/9032

(52) U.S. Cl. CPC G06F 16/9538; G06F 16/90332

(57) ABSTRACT

A method, apparatus, device and medium for searching are provided. In a method, in response to receiving a search request from a user, a search intent of the user is obtained based on the search request. A primary search system and a secondary search system are determined from a natural language model-based search system and a search engine-based search system, respectively, based on the search intent. In a search result for the search request, a primary result matched to the search request from the primary search system and a secondary result matched to the search request from the secondary search system are presented with different display attributes, respectively. Therefore, a search system that is more suitable to the user's search intent may be automatically selected to provide the primary search result. Further, the secondary search result may be used as a supplement to improve the information obtaining efficiency.

### FIELD

Example implementations of the present disclosure relate generally to the field of search, and more particularly, to a method, apparatus, device, and computer-readable storage medium for managing search results obtained by various means.

### BACKGROUND

With the development of search technologies, search systems implemented based on a plurality of search algorithms have been provided. A user may input a search request into a search system. However, the existing search systems may not accurately understand the search request, so that the user has to perform multiple interactions with the search system to obtain a desired search result.

### SUMMARY

In a first aspect of the present disclosure, there is provided a search method. In the method, in response to receiving a search request from a user, a search intent of the user is obtained based on the search request. A primary search system and a secondary search system are determined, based on the search intent, from a natural language model-based search system and a search engine-based search system, respectively. In a search result for the search request, a primary result matched to the search request from the primary search system and a secondary result matched to the search request from the secondary search system are presented with different display attributes, respectively.

In a second aspect of the present disclosure, there is provided a search apparatus. The apparatus comprises: an intent obtaining module configured for, in response to receiving a search request from a user, obtaining a search intent of the user based on the search request; a determining module configured for determining, based on the search intent, a primary search system and a secondary search system from a natural language model-based search system and a search engine-based search system, respectively; and a presenting module configured for, in a search result for the search request, presenting a primary result matched to the search request from the primary search system and a secondary result matched to the search request from the secondary search system with different display attributes, respectively.

In a third aspect of the present disclosure, an electronic device is provided. The electronic device comprises: at least one processing unit; and at least one memory coupled to the at least one processing unit and storing instructions for execution by the at least one processing unit, wherein the instructions, when executed by the at least one processing unit, cause the electronic device to perform a method according to the first aspect of the present disclosure.

In a fourth aspect of the present disclosure, a computer readable storage medium is provided storing a computer program thereon, wherein the computer program, when executed by a processor, causes the processor to implement a method according to the first aspect of the present disclosure.

It would be appreciated that the content described in the Summary section of the present invention is neither intended to identify key or essential features of the implementations of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of various implementations of the present disclosure will become more apparent from the following detailed description in combination with the accompanying drawings. The same or similar reference symbols refer to the same or similar elements throughout the figures, wherein

FIG. 1 illustrates a block diagram of an application environment for performing a search according to one example implementation of the present disclosure;

FIG. 2 illustrates a block diagram of a technical solution for searching according to some implementations of the present disclosure;

FIG. 3 illustrates a block diagram of obtaining and presenting a primary result and a secondary result according to some implementations of the present disclosure;

FIG. 4 illustrates a block diagram of search results according to some implementations of the present disclosure;

FIG. 5 illustrates a block diagram for presenting display attributes of a search result according to some implementations of the present disclosure;

FIG. 6 illustrates a block diagram of presenting a search result based on a search intent according to some implementations of the present disclosure;

FIG. 7 illustrates a block diagram of presenting a search result based on a search intent according to some implementations of the present disclosure;

FIG. 8 illustrates a block diagram of refining a search request based on context information according to some implementations of the present disclosure;

FIG. 9 illustrates a block diagram of presenting a search result based on a search intent according to some implementations of the present disclosure;

FIG. 10 illustrates a flowchart of a method for searching according to some implementations of the present disclosure;

FIG. 11 illustrates a block diagram of an apparatus for searching according to some implementations of the present disclosure; and

FIG. 12 illustrates a block diagram of a device capable of implementing various implementations of the present disclosure.

### DETAILED DESCRIPTION

Implementations of the present disclosure will be described in more detail below with reference to the accompanying drawings. Although some implementations of the present disclosure are shown in the drawings, it would be understood that the present disclosure can be implemented in various forms and should not be interpreted as limited to the implementations described herein. On the contrary, these implementations are provided for a more thorough and complete understanding of the present disclosure. It would be understood that the drawings and implementations of the present disclosure are only for the purpose of illustration and are not intended to limit the scope of protection of the present disclosure.

In the description of implementations of the present disclosure, the term “comprising”, and similar terms should be understood as open inclusion, i.e., “comprising but not limited to”. The term “based on” should be understood as “at least partially based on”. The term “one implementation” or “the implementation” should be understood as “at least one implementation”. The term “some implementations” should be understood as “at least some implementations”. Other explicit and implicit definitions may also be comprised below.

It is understandable that the data involved in this technical proposal (comprising but not limited to the data itself, data obtaining, use, storage, or deletion) shall comply with the requirements of corresponding laws, regulations, and relevant provisions.

It is understandable that before using the technical solution disclosed in respective implementations of the present disclosure, users shall be informed of the type, using scope, and using scenario of personal information involved in the present disclosure in an appropriate way, and be authorized by users according to relevant laws and regulations.

For example, in response to receiving a proactive request from a user, prompt information is sent to the user to explicitly remind the user that a requested operation will require the obtaining and use of personal information of the user, so that the user may independently choose, according to the prompt information, whether to provide personal information to electronic devices, applications, servers or storage media and other software or hardware that perform operations of the technical solution of the present disclosure.

As an optional but non-limiting implementation, in response to receiving a proactive request from a user, the way of sending prompt information to the user may be, for example, a popup window, in which the prompt information may be presented in the form of text. In addition, the popup window may further carry a selection control for the user to choose “agree” or “disagree” to provide personal information to electronic devices.

It is understandable that the above process of notifying and obtaining user authorization is only for the purpose of illustration and does not imply any implementations of the present disclosure. Other ways, to satisfy the requirements of relevant laws and regulations, may also be applied to implementations of the present disclosure.

As used herein, the term “in response to” is to represent a state in which a corresponding event occurs or a condition is satisfied. It will be understood that the timing of the subsequent action performed in response to the event or a condition may not be strongly correlated with the time when the event occurs or the condition is satisfied. For example, in some cases, the subsequent action may be performed immediately when the event occurs or the condition is satisfied; in other cases, the subsequent action may be performed after a period after the event occurs or the condition is satisfied.

### Example Environment

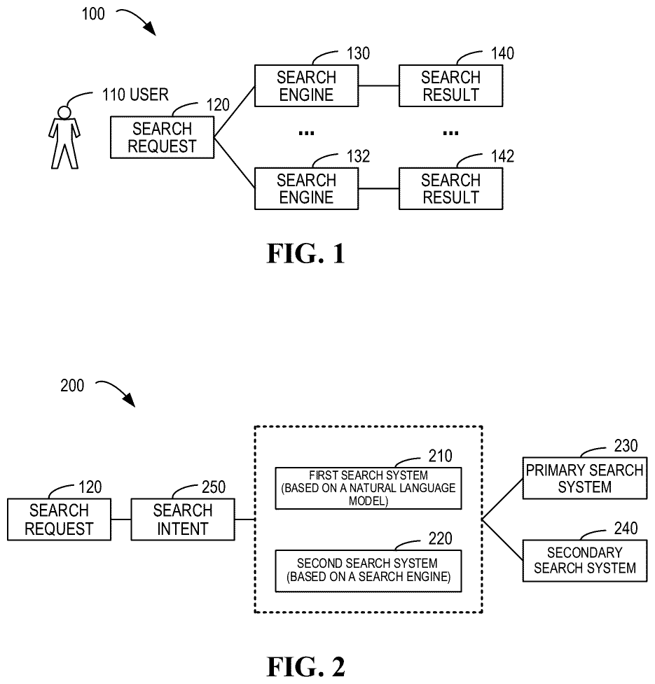

With the development of search technologies, search systems implemented based on a plurality of search algorithms have been provided. A user may input a search request to various search systems and obtain a plurality of results output from the various search systems. An application environment according to one example implementation of the present disclosure is described with reference to FIG. 1, which illustrates a block diagram 100 of an application environment for performing a search according to one example implementation of the present disclosure.

As shown in FIG. 1, a user 110 may generate a search request 120 based on their own needs, and input the search request 120 into different search engines 130, . . . , and 132, respectively. At this point, the respective search engines may output corresponding search results, e.g., the search engine 130 may provide a search result 140, and the search engine 132 may provide a search result 142. However, the plurality of results 140, . . . , 142 are independent of one another, which makes it difficult for the user to obtain overall information about the search request from the plurality of discrete results.

It has been proposed to combine from different search engines to provide a plurality of search results in a single result page. However, the existing technical solutions might fail to fully understand the search request of the user and thus can hardly find a desired answer. As a result, the user has to perform multiple interactions. At this point, it is desirable to search for and present various results obtained via different approaches in a more user-friendly manner, thereby enabling the user to quickly and efficiently obtain the desired answer as a whole.

### SUMMARY OF SEARCH PROCESS

In recent years, with the development of machine learning technology, a large-scale Question & Answer modeling system based on a natural language model (e.g., abbreviated as a large model) has been developed. Users can ask questions to, and receive answers from, large models. Unlike conventional search engines implemented based on retrieval techniques, large models are trained using training data and can accumulate knowledge that is deemed authentic. That is, the large model may extract rich knowledge from the training data and be used to answer various questions of the user.

Since both the storage structure and the working principle of the large model are different from those of the search engine, when the user wants to use the large model and the search engine at the same time, the user has to input a search request into the large model and the search engine respectively, thereby obtaining corresponding search results respectively. At present, a result output by the large model and a result output by the search engine are rather separated from each other. Generally, when the user uses the large model, they can only obtain a result of the large model; when the search engine is used, only a result of the search engine can be obtained. Next, the user needs to manually judge and select a desired search result.

To at least partly solve the drawbacks in the prior art, a technical solution for search is proposed according to one example implementation of the present disclosure. In summary, a search intent of a user may be obtained based on a search request received from the user. Further, it may be determined, based on the search intent, which of a natural language model-based search system and a search engine-based search system is to be used as a primary search system, and the other is to be used as a secondary search system. Search may be performed in the two search system, and among search results with respect to the search request, a primary result matched to the search request from the primary search system and a secondary result matched to the search request from the secondary search system may be presented using different display attributes.

A summary according to one example implementation of the present disclosure will be described with reference to FIG. 2, which shows a block diagram 200 of a technical solution for search according to some implementations of the present disclosure. As shown in FIG. 2, the user 110 may create the search request 120, and the search request 120 here may be a search request expressed in natural language. For example, when the user 110 wants to learn about the 2022 National Basketball Association Champions, the search request 120 can be, for example, “Who is the 2022 national basketball association champion?” or a similar statement.

In the event of receiving the search request 120 from the user 110, the search request 120 can be parsed, and a search intent 250 of the user 110 can be determined. Further, a primary search system 230 and a secondary search system 240 can be determined in two different types of search systems based on the search intent 250. For example, different types of search systems may include a first search system 210 based on a natural language model and a second search system 220 based on a search engine. Further, a primary result can be obtained from the primary search system 230 and a secondary result can be obtained from the secondary search system 240, thereby presenting search results for the search request 120. According to one example implementation of the present disclosure, the primary result matched to the search request 120 from the primary search system 230 and the secondary result matched to the search request 120 from the secondary search system 240 may be presented with different display attributes, respectively.

With example implementations of the present disclosure, during the user obtaining a reply to the search request 120, a search system that is more appropriate to the user's search intent can be automatically selected to provide the primary result. Further, the secondary result output by the secondary search system may be supplemented so that more detailed information about the search request can be obtained. In this way, it is convenient for the user to obtain a desired answer as a whole, thereby improving the efficiency of obtaining information.

With example implementations of the present disclosure, when different results are presented in different display attributes, the primary result of more interest can be presented to the user in a more prominent manner, thereby improving the efficiency of the user in obtaining information. According to one example implementation of the present disclosure, the search method described above may be performed in a conversational search system. In this way, the user may obtain answers to questions of interest in a chat format.

### Detailed Description of Search Process

While the summary according to one example implementation of the present disclosure has been described, more details regarding search will be provided below. According to one example implementation of the present disclosure, the conversational search system may comprise a plurality of different types of search systems, for example, a natural language model (e.g., a large model) based search system, and a search engine based search system. It should be understood that a natural language model-based search system can flexibly process a search request expressed in a natural language, and such a search system is particularly suitable for processing a search request regarding questions such as objective facts, empirical methods, views and evaluations, language translation, data processing and the like.

Further, a search engine-based search system can be accurately matched to various keywords in a search request, and such a search system is particularly suitable for processing resource-type searches related to data (e.g., multimedia data such as vocabulary, audio, video, etc.), applications, tools, services, commodities, etc. With the example implementations of the present disclosure, a variety of search systems may provide a more abundant source of data to the user, thereby facilitating the provision of data matched to various aspects of a search request to the user.

According to one example implementation of the present disclosure, specific content of the search request 120 is not limited, but the search request 120 may include a plurality of formats expressed in natural language. For example, the search request 120 may include a question expressed in natural language from the user 110. For another example, the search request 120 may include one or more keywords expressed in natural language, etc. With the example implementations of the present disclosure, the user 110 may flexibly describe in natural language the questions they desire to understand, without having to understand constraint rules for building search requests. In this way, the search service may be provided to the user 110 in a more friendly manner.

According to one example implementation of the present disclosure, the search request 120 may be parsed using a natural language-based pre-processing model, to further obtain queries that are respectively input to different search systems. Here, the pre-processing model may be trained based on historical data, for example, using historical queries employed by a large number of users in historical searches to obtain satisfactory results as training data. For different search systems, different pre-processing models may be employed.

In particular, for natural language-based search systems, the pre-processing model may translate search requests expressed in colloquial terms of text and/or speech input into the form of a query. For example, normalization operations may be performed on search requests expressed in different ways. For example, search requests such as “please tell me the 2022 national basketball association champion”, “who is the 2022 national basketball association champion”, “who is the National Basketball Association Champion? In 2022” may be translated into “who is the 2022 national basketball association champion?” For another example, suppose the user wants to know the specific business hours of the bank, the pre-processing model may translate search requests such as “when will the bank open?” “when to close?” and “does the bank take a lunch break?” into “bank business hours”.

For another example, regarding a search engine based search system, the pre-processing model may translate a search request expressed in colloquial terms of text and/or speech input into a form represented by one or more keywords. For example, a search request regarding the champion may be translated into a query consisting of various keywords “2022 basketball association champion”, a search request for business hours may be translated into “bank business hours”, etc.

Alternatively and/or additionally, different types of search systems may be served separately using the same pre-processing model. At this point, the pre-processing model may include two inputs: an input to indicate the search request, and an additional input to indicate the type of the search system. At this point, queries for different types of search systems may be output using a single pre-processing model. Although the complexity of obtaining the pre-processing model is increased, only a single pre-processing model is involved in the search process, thereby reducing the complexity of the conversational search system.

Alternatively and/or additionally, the translation process may be implemented using a large model. At this point, a search request may be first input into the large model to obtain a query expressed in written language, and then a corresponding query may be input into each search system to obtain a result matched to the search request. With the example implementations of the present disclosure, the user can perform a search without having to manually translate colloquial, incoherent expressions into written expressions before performing the search. Instead, by leveraging the natural language understanding capability of the large model, the user can make a colloquial expression as if they were chatting, and the large model can translate the expression into a comprehensible search request.

Description is presented below to a process for selecting a primary search system from among a plurality of search systems based on a search intent. According to one example implementation of the present disclosure, the search request 120 may be analyzed using an analysis model to determine the search intent 250 of the user 110. For example, the search intent 250 may be determined using a specialized model trained based on historical data, or using a large model.

According to one example implementation of the present disclosure, the search intent 250 may include, for example, a question-type search intent and a resource-type search intent. In particular, question-like search intents mainly involve search requests regarding objective facts, empirical methods, views and evaluations, language translation, data processing, etc. For example, the user may query the specific meaning of a certain term, query related information of a certain historical event, translate a text input into specified language, etc. Such requests may be more suitable for processing by large models. For another example, resource-type search intents may involve resource-type search requests related to data resources (e.g., multi-media data such as vocabulary, audio, video, etc.), applications, tools, services, commodities, etc. For example, the user may search a network for a certain song, teleplay, an application for performing a certain function, or a store that sells a certain product, etc. Such requests are more suitable for processing by search engines.

Then, based on the determined search intent 250, a primary search system 230 and a secondary search system 240 can be determined from the first search system 210 and the second search system 220. Here, the primary search system 230 refers to a search system that can provide primary results of more interest to the user; And the user may be less interested in search results provided by the secondary search system 240, which, however, may serve as a support, supplement, and reference to the primary results so that the user can obtain a more comprehensive understanding of the desired question.

According to one example implementation of the present disclosure, the primary search system 230 may first be determined based on the search intent 250, and then other search system than the primary search system 230 among the first search system 210 and the second search system 220 may serve as the secondary search system 240. In this manner, the primary search system 230 and the secondary search system 240 may be determined in a more convenient and efficient manner.

Specifically, if the search intent 250 is determined to be of the question type, the first search system 210 (i.e., the large model) may be selected as the primary search system 230. As another example, if the search intent 250 is of the resource type, the second search system 220 (i.e., a search engine) may be selected as a primary search system 422. In comparison, large models are good at accumulating historical knowledge, and search engines can provide more accurate real-time data. In this manner, an appropriate search system may be automatically selected based on the user's search intent 250, and further search results that are more consistent with the user's search intent 250 can be found by taking full advantage of various search systems.

According to one example implementation of the present disclosure, a more suitable search system may be automatically selected for the user. In other words, it may be determined, based on the search intent, which search system is more suitable for processing the user's search request 120 and further that search system is used as the primary search system, and results from the primary search system are presented in a visually more distinct format a search result 330.

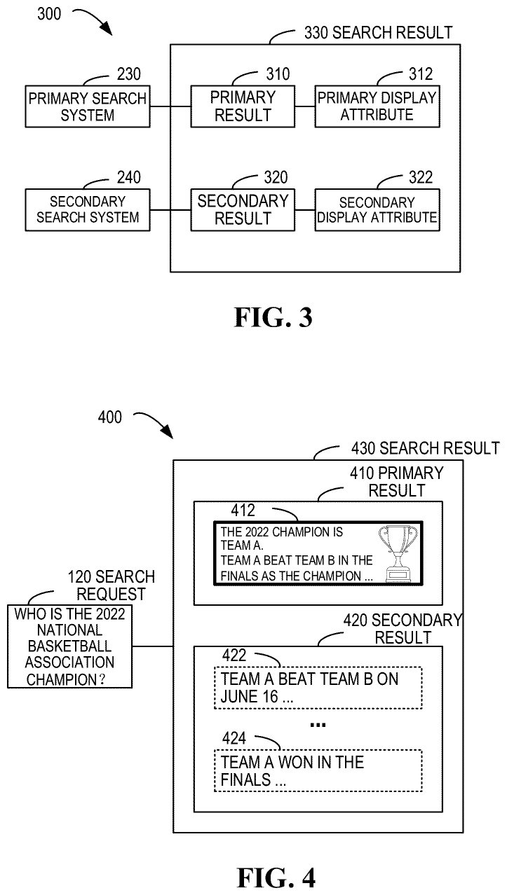

More details of presenting search results are described with reference to FIG. 3, which illustrates a block diagram 300 of obtaining and presenting a primary result and a secondary result according to some implementations of the present disclosure. A primary result 310 may be obtained by performing a search in the primary search system 230 with the search request 120, and a secondary result 320 may be obtained by performing a search in the secondary search system 240 with the search request 120.

Further, the primary result 310 may be presented in the search result 330 by using a primary display attribute 312, and the secondary result 320 may be presented in the search result 330 by using a secondary display attribute 322. Here, the search result 330 is an overall result presented for the search query 120. It should be appreciated that the first search system 210 and the second search system 220 have respective areas of expertise. In the search result 330, results from different search systems are displayed in different formats, so that a user can distinguish the results from different search systems, determine the advantage and disadvantage of each search result and further select a result that better meets their own requirements. In this way, the user may be attracted to the primary result from the primary search system as quickly as possible, thereby obtaining the desired answer. Further, the secondary result from the secondary search system may be used as a supplement to the primary result and allow the user to have a comprehensive understanding of the desired answer.

According to one example implementation of the present disclosure, each of the primary result 310 and the secondary result 320 may include different content. For example, each result may include any of: a reply to the search request from the natural language model-based search system; or at least one web page data matched to the search request from the search engine-based search system.

More content of the search result 330 presented in various formats is described below with reference to FIG. 4. This figure illustrates a block diagram 400 of search results according to some implementations of the present disclosure. As shown in FIG. 4, it is assumed that the search request 120 is “who is the 2022 national basketball association champion?” The first search system 210 based on the natural language model may be used as the primary search system, and the second search system 220 based on the search engine may be used as the secondary search system.

A primary result 410 and a secondary result 420 matched to the search request 120 may be obtained respectively, and a search result 430 as shown in FIG. 4 may be presented. Here, the primary result 410 may include a reply 412 to the search request 120. For example, the reply 412 may provide an answer directly to the user's question, or a brief reply, etc. The secondary result 420 may include at least one web page data 422, . . . , and 424 obtained based on the search request 120. The web page data 422, . . . , and 424 herein may include more detailed information about the search request 120, e.g., web page data on news about the finals, etc. At this point, the web page data may serve as a support, supplement, and/or reference for the reply 412, thereby providing more comprehensive information to the user 110.

As shown in FIG. 4, different results can be presented in different formats in the search result 430 for the search request 120. For example, the primary result 410 may be presented with a primary display attribute (e.g., in a black thick-line frame) and the secondary result 420 may be presented with a secondary display attribute (e.g., in a dashed frame) that is different from the primary display attribute. It should be appreciated that the two display attributes herein may exhibit different visual effects, e.g., the primary display attribute may be more prominent so as to highlight that the result may be a result of more interest to the user.

In determining the format used to present the various results, it should be ensured that the result from the primary search system 230 is presented in a more prominent manner. In FIG. 4, the primary result 310, shown in a black thick-line frame, is more prominent and may attract more attention of the user 110. In this way, a more prominent presentation may draw more attention of the user, thereby reducing the risk of the user missing correct search results.

According to one example implementation of the present disclosure, the conversational search system may determine display attributes of results from various search systems based on the search intent. The primary result 410 from the large model may be presented in a more prominent manner in the search result 430. For example, the reply 412 to the search request 120 may be presented at a head location of the search result, and the secondary result 420 including the plurality of web page data may be presented at a location after the primary result 410. When viewing the search result 430, the user 110 may first see the reply 412 that is at a significant location, thereby quickly obtaining the correct answer output by the large model. Alternatively and/or additionally, the subsequent secondary result 420 may serve as a support, supplement, and reference for the primary result 410 in such a manner as to allow the user 110 to have a full understanding of the desired answer.

According to one example implementation of the present disclosure, the web page data may include refined information associated with the reply, and/or extended information associated with the reply. Here, the refined information may explain the reply in a more detailed manner. For example, in the example of the basketball league champions, the refined information may include detailed introductions about team A, such as team history, player introductions, etc. The expanded information may include more historical events associated with the team A obtaining the champion, e.g., the time and score of each game in the national basketball league, etc.

According to one example implementation of the present disclosure, An interface may be provided to the user for specifying a relationship between the primary and secondary results. The interface may include, for example, refined information, extended information and other options. In this manner, search results more tailored to the user's expectations may be provided based on the user's interactions with the interface.

According to one example implementation of the present disclosure, in determining the primary display attribute 312 and the secondary display attribute 322, a significance of a display attribute of a format associated with the primary search system 230 may be set higher than a significance of a display attribute of a format associated with the secondary search system 240. It should be understood that the display attribute may include multiple aspects of content, for example, including but not limited to at least one of: a display location, a display area, a display font, a display font size, a font color, and a background color. Further details regarding display attributes are described with reference to FIG. 5, which illustrates a block diagram 500 for presenting display attributes of search results according to some implementations of the present disclosure.

As shown in FIG. 5, a display attribute 510 may include a display location 511 for indicating the location of a result in the overall search result 330. When the display attribute is embodied in different aspects, the significance can be expressed in different manners. For example, where the display attribute 510 relates to the display location 511, it may be considered that a display location at the head of the search result 330 has a higher significance and a display location at the tail of the search result 330 has a lower significance. In determining to present the display attributes of the primary result 310 and the secondary result 320, the display location of the result output by the primary search system 230 may be set at a prominent location at the head of the search result 330, and the display location of the result output by the secondary search system 240 may be set at a less prominent location behind the head of the search result 330.

According to one example implementation of the present disclosure, the display attribute 510 may include a display area 512 for indicating the area occupied by a result in the overall search result. Where the display attribute 510 relates to the display area 512, it can be considered that a larger display area has a higher significance, and a smaller display area may be considered to have a lower significance. During determining the display attributes for presenting the primary result 310 and the secondary result 320, the result output by the primary search system 230 may be presented in a larger display area and the result output by the secondary search system 240 may be presented in a smaller display area.

According to one example implementation of the present disclosure, the display attribute 510 may include a display font 513 for indicating the font of a result used in the overall search result. Where the display attribute 510 relates to the display font 513, it may be considered that, for example, a bold, italic, underlined font or the like has a higher significance, and that a regular font has a lower significance. During determining the display attribute for presenting the primary result 310 and the secondary result 320, the result output by the primary search system 230 may be presented in a bold font, and the result output by the secondary search system 240 may be presented in a regular font.

According to one example implementation of the present disclosure, the display attribute 510 may include a display font size 514 for indicating the font size of a result in the overall search result. Where the display attribute 510 relates to the display font size 514, it may be considered that a larger font size has a higher significance and a smaller font size has a lower significance. During determining the display attributes for presenting the primary result 310 and the secondary result 320, the result output by the primary search system 230 may be presented in a larger font size and the result output by the secondary search system 240 may be presented in a smaller font size.

According to one example implementation of the present disclosure, the display attribute 510 may include a font color 515 for indicate the color of a result presented in the overall search result. Where the display attributes 510 relate to the font color 515, it may be considered that colors such as red, orange or the like have a higher significance, and black, grey or the like have a lower significance. During determining the display attributes for presenting the primary result 310 and the secondary result 320, the result output by the primary search system 230 may be presented in red (e. g., presenting important parts such as the title) and the result output by the secondary search system 240 may be presented in black.

According to one example implementation of the present disclosure, the display attribute 510 may include a background color 516 for indicating the base color of a result in the overall search result. Where the display attribute 510 relates to the background color 516, it may be considered that a color such as yellow, green or the like has a higher significance, and a color such as white, gray or the like has a lower significance. During determining the display attributes for presenting the primary result 310 and the secondary result 320, the result output by the primary search system 230 may be presented in yellow (e.g., highlighting important parts such as the title) and the result output by the secondary search system 240 may be presented in white.

It should be appreciated that while various aspects of the display attribute 510 have been described above by way of example, each of the aspects described above can be adjusted individually and/or in combination to present the result output by the primary search system 230 in a more prominent manner. For example, a flashing marker may be added near the result output by the primary search system 230, etc. In this manner, the advantage and disadvantage of each search system may be automatically determined, thereby presenting more accurate search results to the user in a more prominent manner.

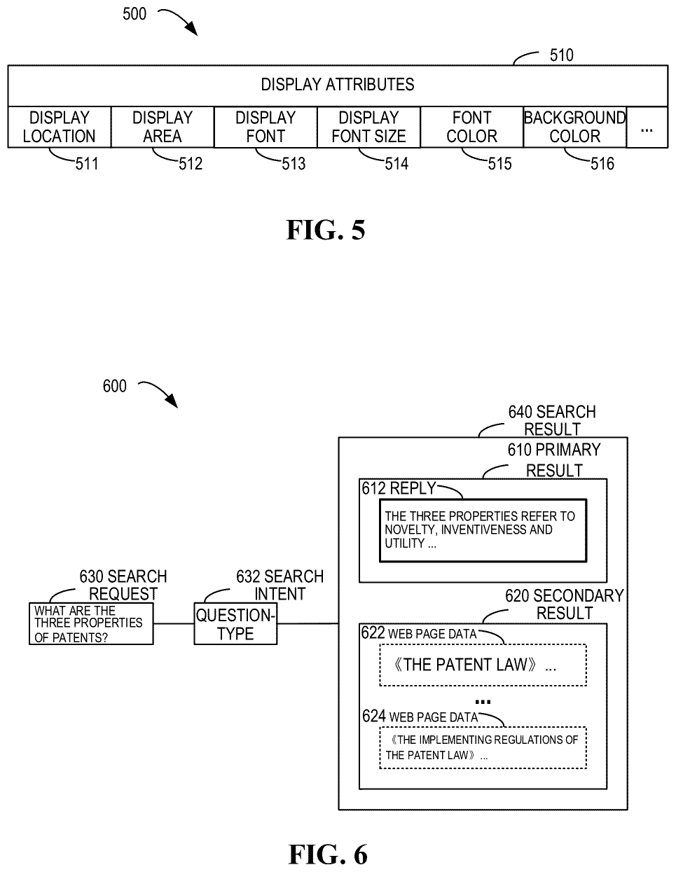

Search results regarding a question-type search intent are described below with reference to FIG. 6, which illustrates a block diagram 600 of presenting a search result based on a search intent, according to some implementations of the present disclosure. As shown in FIG. 6, assuming that a user wishes to find patent-related knowledge, the user can input a search request 630 into the conversational search system in order to describe they want to know about the “three properties of patents”. A search intent 632 of the user may be determined as a “question type” in the manner described above, at which point, the first search system 210 implemented based on a large model may serve as the primary search system 230 and a second search system 220 implemented based on a search engine may serve as the secondary search system 240.

Further, a search result 640 can be presented as shown in FIG. 6, in which a primary result 610 comprises a reply 612 to the search request 630. The reply 612 is located at a significant location at the head of the search result 640 and briefly answers the question of the user, i.e., the reply 612 provides summary information pf the search result. At this point, the user can clearly know the answer to the question. Further, a secondary result 620 gives a basis for the reply 612, i.e., the reply 612 is given based on web page data 622, . . . , 624, etc. In this way, an answer to the search request and a specific basis for obtaining the answer can be provided to the user, thereby allowing the user to obtain information and knowledge more effectively.

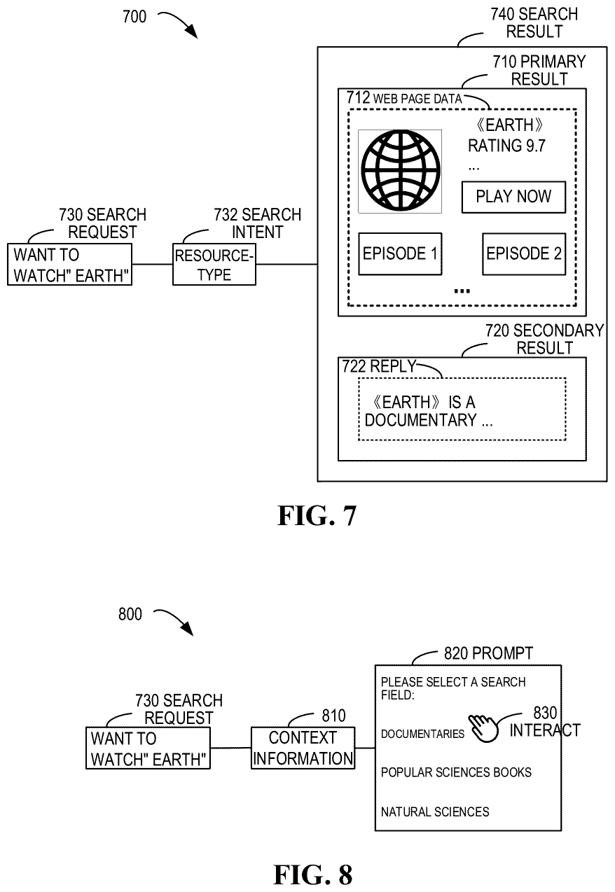

While search results for question-type search intents have been described with reference to FIGS. 2 to 6, a search result for the resource-type search intent is described below with reference to FIG. 7, which illustrates a block diagram 700 of presenting a search result based on a search intent, according to some implementations of the present disclosure. As shown in FIG. 7, suppose that <<Earth>> is a recent hot movie and TV resource, and the user wants to find a playback address of “Earth”. At this point, a search request 730 of the user can be “want to watch ‘Earth’”. It may be determined that the search request 730 relates to a resource-type search intent 732, and further, a second search system implemented based on a search engine may serve as the primary search system, and a first search system implemented based on a large model may serve as the secondary search system.

Further, in a search result 740, a primary result 710 output by the secondary search system may be presented in a larger area at a significant location of the head. At this point, the primary result 710 may include a plurality of web page data 712, such as a poster, name, rating, playback button for the movie resource, and links for accessing each episode of the movie resources (e.g., “first episode”, “second episode”, etc.).

In this example, since the search intent 732 explicitly indicates that the user wishes to find the playback addresses of the movie resource, in this manner, it may be convenient for the user to quickly find the playback addresses to browse the movie resource. Further, a secondary result 720 is displayed after the web page data 712 that provides the movie resource. In particular, a reply 722 to the search request 730 may be provided, which indicates a summary of the answer to the question, e.g., a brief introduction to <<Earth>>, etc. In this way, on the one hand, support is given to the user to quickly find a desired resource, and on the other hand, a relevant brief reply can be provided to the user, thereby facilitating the user to comprehensively understand the searched content.

According to one example implementation of the present disclosure, the search request may have a plurality of ambiguous meanings, and the content that the user desires to search may not be accurately determined only based on the search request input by the user. At this time, context information associated with the search request may be obtained, and a prompt to refine the search request is provided to the user based on the context information. More details are described below with reference to FIG. 8, which illustrates a block diagram 800 of refining a search request based on context information, according to some implementations of the present disclosure.

As shown in FIG. 8, suppose that “Earth” in the search request 730 contains multiple meanings, at which point context information 810 may be obtained. The context information 810 can include a variety of aspects of content including, for example, but not limited to, the context in which the user submitted the search request 730, current news data, a plurality of search fields associated with the search request 730, and so on. Given that “Earth” is found to be related to a plurality of search fields, relevant search fields (e.g., documentaries, popular sciences, and natural sciences) may be presented to the user in a prompt 820 to refine the search request. The user may interact with the prompt 820.

As shown in FIG. 8, when the interaction 830 relates to a “documentary”, the search request 730 may be refined to “want to watch the documentary ‘Earth’”. Further, primary and secondary results may be obtained by performing searches in various search systems with the refined search request. In other words, a more accurate search result may be obtained within the scope of documentaries at this point. In the example of FIG. 8, after the user selects the “documentary”, the search result as shown in FIG. 7 may be presented. In this manner, the content that the user desires to retrieve may be determined at a finer granularity, thereby providing a more accurate search result.

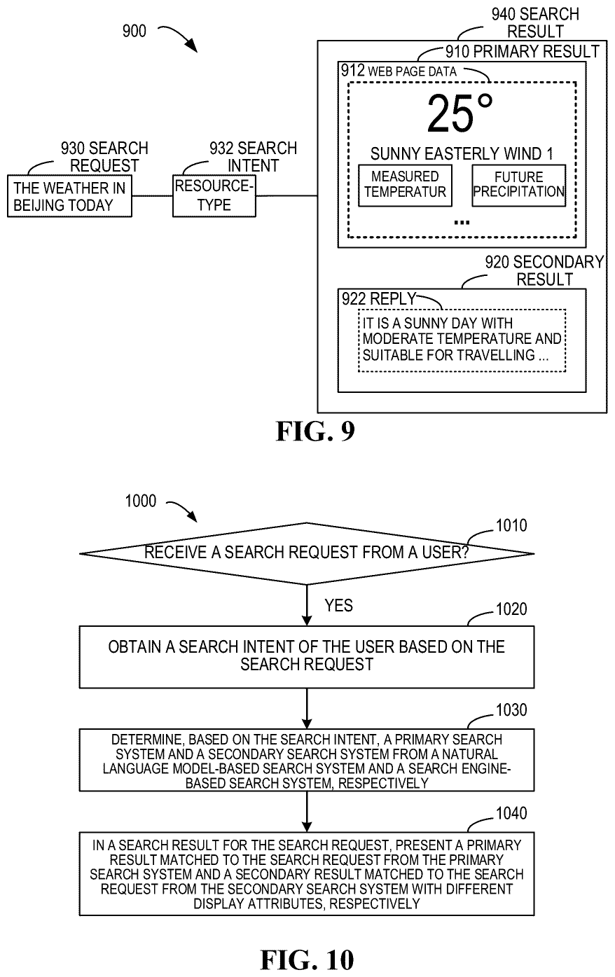

FIG. 9 illustrates a block diagram 900 of presenting a search result based on a search intent according to some implementations of the present disclosure. As shown in FIG. 9, assuming that the user expects to know the weather in Beijing, at this point the search request 930 may be expressed as “the weather in Beijing today”, for example. A corresponding search intent 932 can be determined to be of the resource type, at which point the search engine can be treated as the primary search system and the large model can be treated as the secondary search system. As shown in FIG. 9, a primary result 910 from the search engine may be presented at a prominent location of the search result, and web page data 912 in the primary result 910 may be, for example, data from real-time updates of the weather station.

It should be appreciated that the web page data herein may include, for example, the specific content of the web page data (e.g., temperature 25 degrees, etc.), and may also include a portal pointing to real-time web page data (e.g., a link to access actual measured temperatures, a link to range future precipitation and the like in FIG. 9). Further, a secondary result 920 output by the large model may be presented at a location below the primary result 910, which secondary result 920 may prompt the user that it is a sunny day with moderate temperatures and suitable for traveling. In this way, it may be convenient for the user to know multi-aspect information about the Beijing weather.

It should be appreciated that although the plurality of content in the search result has been described above with reference to the figures, alternatively and/or additionally, the search result may include more or less content. For example, the types and names of the various search systems used may be provided in the search result. For example, it may be displayed near result A: this result is provided by a large model (with a name ***); As another example, it may be displayed near result B: this result is provided by a search engine (with a name ***). Alternatively and/or additionally, portals for accessing various search systems can be provided in the search result, e.g., a portal address for accessing a large model can be displayed near result A, a portal address for accessing a search engine can be displayed near result B, etc. In this manner, it is easy for the user to learn more information about the search system, thereby facilitating the user to further find desired information by using individual search systems.

It should be understood that while the process illustrated above describes only a single first search system and a single second search system, each search system herein may comprise one or more search systems. For example, the first search system may comprise two or more large models, and the primary result may be a combination of results from a plurality of large models. For another example, the second search system may comprise two or more search engines, and the secondary result may be a ranked search result from the plurality of search engines, etc.

With the example implementations of the present disclosure, a primary search system better matched to the search request may be automatically selected from a plurality of search systems, taking into account the user's search intent. Further, results obtained in different manners may be presented in different formats, thereby facilitating the user in distinguishing between results and further improving the information obtaining efficiency for the user. In particular, the results from the primary search system may be presented in a more prominent manner, thereby facilitating the user to obtain desired information in a more rapid and efficient manner.

### Example Process

FIG. 10 illustrates a flowchart of a method 1000 for searching according to some implementations of the present disclosure. At a block 1010, it is determined whether a search request is received from a user. If the search request is received, the method 1000 proceeds to a block 1020, and a search intent of the user is obtained based on the search request. At a block 1030, a primary search system and a secondary search system are determined based on the search intent from a natural language model-based search system and a search engine-based search system, respectively. At a block 1040, in a search result for the search request, a primary result matched to the search request from the primary search system and a secondary result matched to the search request from the secondary search system are presented with different display attributes, respectively.

According to an example implementation of the present disclosure, the search intent comprises at least one of a question-type search intent and a resource-type search intent, and determining the primary search system comprises at least one of: in response to determining that the search intent is a question-type search intent, selecting the natural language model-based search system as the primary search system; and in response to determining that the search intent is a resource-type search intent, selecting the search engine-based search system as the primary search system.

According to an example implementation of the present disclosure, determining the secondary search system comprises: selecting, in the natural language model-based search system and the search engine-based search system, other search system than the primary search system as the secondary search system.

According to an example implementation of the present disclosure, any of the primary result and the secondary result comprises at least one of: a reply to the search request from the natural language model-based search system; and at least one web page data matched to the search request from the search engine-based search system.

According to an example implementation of the present disclosure, the at least one web page data comprises at least one of: refined information associated with the reply, and extended information associated with the reply.

According to an example implementation of the present disclosure, a significance of the display attribute of the primary result is higher than a significance of the display attribute of the secondary result.

According to an example implementation of the present disclosure, the display attribute comprises at least one of: a display location, a display area, a display font, a display font size, a font color, and a background color.

According to an example implementation of the present disclosure, the method 1000 further comprises: extracting a primary query and a secondary query matched to the search request, respectively, wherein the primary result is obtained in the primary search system based on the primary query and the secondary result is obtained in the secondary search system based on the secondary query.

According to an example implementation of the present disclosure, the method 1000 further comprises: obtaining context information associated with the search request; providing, to the user, a prompt to refine the search request based on the context information; and obtaining the primary result and the secondary result based on the user's interaction for the prompt.

According to an example implementation of the present disclosure, the method 1000 is performed in a conversational search page.

### Example Apparatus and Equipment

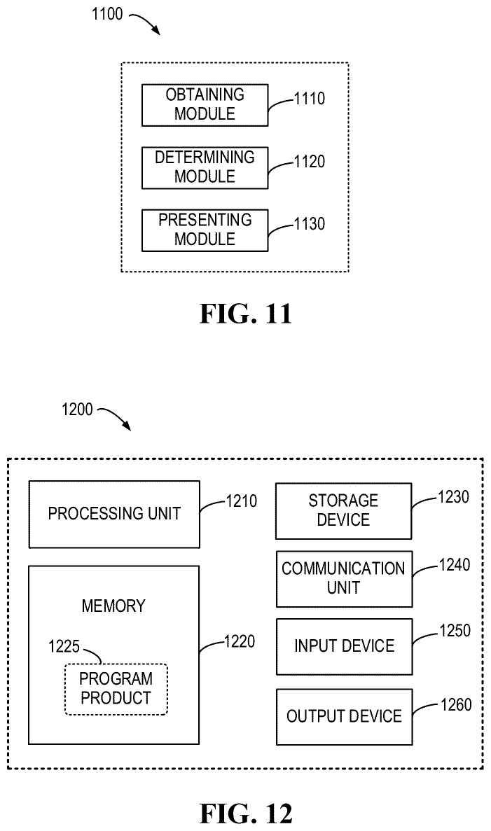

FIG. 11 illustrates a block diagram of an apparatus 1100 for searching according to some implementations of the present disclosure. The apparatus 1100 comprises: an intent obtaining module 1110 configured for, in response to receiving a search request from a user, obtaining a search intent of the user based on the search request; a determining module 1120 configured for determining, based on the search intent, a primary search system and a secondary search system from a natural language model-based search system and a search engine-based search system, respectively; and a presenting module 1130 configured for, in a search result for the search request, presenting a primary result matched to the search request from the primary search system and a secondary result matched to the search request from the secondary search system with different display attributes, respectively.

According to an example implementation of the present disclosure, the search intent comprises at least one of a question-type search intent and a resource-type search intent, and determining the primary search system comprises at least one of: in response to determining that the search intent is a question-type search intent, selecting the natural language model-based search system as the primary search system; and in response to determining that the search intent is a resource-type search intent, selecting the search engine-based search system as the primary search system.

According to an example implementation of the present disclosure, determining the secondary search system comprises: selecting, in the natural language model-based search system and the search engine-based search system, other search system than the primary search system as the secondary search system.

According to an example implementation of the present disclosure, any of the primary result and the secondary result comprises at least one of: a reply to the search request from the natural language model-based search system; and at least one web page data matched to the search request from the search engine-based search system.

According to an example implementation of the present disclosure, the at least one web page data comprises at least one of: refined information associated with the reply, and extended information associated with the reply.

According to an example implementation of the present disclosure, a significance of the display attribute of the primary result is higher than a significance of the display attribute of the secondary result.

According to an example implementation of the present disclosure, the display attribute comprises at least one of: a display location, a display area, a display font, a display font size, a font color, and a background color.

According to an example implementation of the present disclosure, the apparatus further comprises: an extracting module, configured for extracting a primary query and a secondary query matched to the search request, respectively, wherein the primary result is obtained in the primary search system based on the primary query and the secondary result is obtained in the secondary search system based on the secondary query.

According to an example implementation of the present disclosure, the apparatus further comprises: a context information obtaining, configured for obtaining context information associated with the search request; a providing module, configured for providing, to the user, a prompt to refine the search request based on the context information; and a result obtaining module, configured for obtaining the primary result and the secondary result based on the user's interaction for the prompt.

According to an example implementation of the present disclosure, the apparatus is performed in a conversational search page.

FIG. 12 shows a block diagram of a device 1200 that can implement a plurality of implementations of the present disclosure. It would be understood that the electronic device 1200 shown in FIG. 12 is only an example and should not constitute any restriction on the function and scope of the implementations described herein.

As shown in FIG. 12, the electronic device 1200 is in the form of a general computing device. The components of the electronic device 1200 may comprise but are not limited to, one or more processors or processing units 1210, a memory 1220, a storage device 1230, one or more communication units 1240, one or more input devices 1250, and one or more output devices 1260. The processing unit 1210 may be an actual or virtual processor and can execute various processes according to the programs stored in the memory 1220. In a multiprocessor system, a plurality of processing units execute computer executable instructions in parallel to improve the parallel processing capability of the electronic device 1200.

The electronic device 1200 typically comprises a variety of computer storage medium. Such medium may be any available medium that is accessible to the electronic device 1200, comprising but not limited to volatile and non-volatile medium, removable, and non-removable medium. The memory 1220 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1230 may be any removable or non-removable medium and may comprise a machine-readable medium, such as a flash drive, a disk, or any other medium, which can be used to store information and/or data (such as training data for training) and can be accessed within the electronic device 1200.

The electronic device 1200 may further comprise additional removable/non-removable, volatile/non-volatile storage medium. Although not shown in FIG. 12, a disk driver for reading from or writing to a removable, non-volatile disk (such as a “floppy disk”), and an optical disk driver for reading from or writing to a removable, non-volatile optical disk can be provided. In these cases, respective driver may be connected to the bus (not shown) by one or more data medium interfaces. The memory 1220 may comprise a computer program product 1225, which has one or more program modules configured to perform various methods or acts of various implementations of the present disclosure.

The communication unit 1240 communicates with a further computing device through the communication medium. In addition, functions of components in the electronic device 1200 may be implemented by a single computing cluster or a plurality of computing machines, which can communicate through a communication connection. Therefore, the electronic device 1200 may be operated in a networking environment with a logical connection with one or more other servers, a network personal computer (PC), or another network node.

The input device 1250 may be one or more input devices, such as a mouse, a keyboard, a trackball, etc. The output device 1260 may be one or more output devices, such as a display, a speaker, a printer, etc. The electronic device 1200 may also communicate with one or more external devices (not shown) through the communication unit 1240 as required. The external device, such as a storage device, a display device, etc., communicates with one or more devices that enable users to interact with the electronic device 1200, or communicate with any device (for example, a network card, a modem, etc.) that makes the electronic device 1200 communicate with one or more other computing devices. Such communication may be executed via an input/output (I/O) interface (not shown).

According to the example implementation of the present disclosure, a computer-readable storage medium is provided, on which a computer-executable instruction or computer program is stored, wherein the computer-executable instructions or the computer program is executed by the processor to implement the method described above. According to the example implementation of the present disclosure, a computer program product is also provided. The computer program product is physically stored on a non-transient computer-readable medium and comprises computer-executable instructions, which are executed by the processor to implement the method described above. According to the example implementation of the present disclosure, a computer program product is provided, on which computer program is stored and the program implements the method described above when executed by a processor.

Various aspects of the present disclosure are described herein with reference to the flow chart and/or the block diagram of the method, the device, the equipment, and the computer program product implemented according to the present disclosure. It would be understood that respective block of the flowchart and/or the block diagram and the combination of respective blocks in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device, and/or other devices to work in a specific way. Therefore, the computer-readable medium containing the instructions comprises a product, which comprises instructions to implement various aspects of the functions/acts specified in one or more blocks in the flowchart and/or the block diagram.

The computer-readable program instructions may be loaded onto a computer, other programmable data processing apparatus, or other devices, so that a segment of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions, and operations of the system, the method, and the computer program product implemented according to the present disclosure. In this regard, respective block in the flowchart or the block diagram may represent a part of a module, a program segment, or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that respective block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Respective implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of respective implementation, or to enable other ordinary skills in the art to understand the various implementations disclosed herein.

1. A method for searching, comprising:
in response to receiving a search request from a user, obtaining a search intent of the user based on the search request;
determining, based on the search intent, a primary search system and a secondary search system from a natural language model-based search system and a search engine-based search system, respectively; and
in a search result for the search request, presenting a primary result matched to the search request from the primary search system and a secondary result matched to the search request from the secondary search system with different display attributes, respectively.

2. The method of claim 1, wherein the search intent comprises at least one of a question-type search intent and a resource-type search intent, and determining the primary search system comprises at least one of:
in response to determining that the search intent is a question-type search intent, selecting the natural language model-based search system as the primary search system; and
in response to determining that the search intent is a resource-type search intent, selecting the search engine-based search system as the primary search system.

3. The method of claim 2, wherein determining the secondary search system comprises:
selecting, in the natural language model-based search system and the search engine-based search system, other search system than the primary search system as the secondary search system.

4. The method of claim 1, wherein any of the primary result and the secondary result comprises at least one of:
a reply to the search request from the natural language model-based search system; and
at least one web page data matched to the search request from the search engine-based search system.

5. The method of claim 4, wherein the at least one web page data comprises at least one of: refined information associated with the reply, and extended information associated with the reply.

6. The method of claim 1, wherein a significance of the display attribute of the primary result is higher than a significance of the display attribute of the secondary result.

7. The method of claim 6, wherein the display attribute comprises at least one of: a display location, a display area, a display font, a display font size, a font color, and a background color.

8. The method of claim 1, further comprising: extracting a primary query and a secondary query matched to the search request, respectively, wherein the primary result is obtained in the primary search system based on the primary query and the secondary result is obtained in the secondary search system based on the secondary query.

9. The method of claim 1, further comprising:
obtaining context information associated with the search request;
providing, to the user, a prompt to refine the search request based on the context information; and
obtaining the primary result and the secondary result based on the user's interaction for the prompt.

10. The method of claim 1, wherein the method is performed in a conversational search page.

11. An electronic device, comprising:
at least one processing unit; and
at least one memory coupled to the at least one processing unit and storing instructions for execution by the at least one processing unit, the instructions, when executed by the at least one processing unit, causing the electronic device to perform a method for searching, the method comprising:
in response to receiving a search request from a user, obtaining a search intent of the user based on the search request;
determining, based on the search intent, a primary search system and a secondary search system from a natural language model-based search system and a search engine-based search system, respectively; and
in a search result for the search request, presenting a primary result matched to the search request from the primary search system and a secondary result matched to the search request from the secondary search system with different display attributes, respectively.

12. The device of claim 11, wherein the search intent comprises at least one of a question-type search intent and a resource-type search intent, and determining the primary search system comprises at least one of:
in response to determining that the search intent is a question-type search intent, selecting the natural language model-based search system as the primary search system; and
in response to determining that the search intent is a resource-type search intent, selecting the search engine-based search system as the primary search system.

13. The device of claim 12, wherein determining the secondary search system comprises:
selecting, in the natural language model-based search system and the search engine-based search system, other search system than the primary search system as the secondary search system.

14. The device of claim 11, wherein any of the primary result and the secondary result comprises at least one of:
a reply to the search request from the natural language model-based search system; and
at least one web page data matched to the search request from the search engine-based search system.

15. The device of claim 14, wherein the at least one web page data comprises at least one of: refined information associated with the reply, and extended information associated with the reply.

16. The device of claim 11, wherein a significance of the display attribute of the primary result is higher than a significance of the display attribute of the secondary result.

17. The device of claim 16, wherein the display attribute comprises at least one of: a display location, a display area, a display font, a display font size, a font color, and a background color.

18. The device of claim 11, further comprising: extracting a primary query and a secondary query matched to the search request, respectively, wherein the primary result is obtained in the primary search system based on the primary query and the secondary result is obtained in the secondary search system based on the secondary query.

19. The device of claim 11, further comprising:
obtaining context information associated with the search request;
providing, to the user, a prompt to refine the search request based on the context information; and
obtaining the primary result and the secondary result based on the user's interaction for the prompt.

20. A non-transitory computer readable storage medium storing a computer program thereon, the computer program, when executed by a processor, causing the processor to implement a method for searching, the method comprising:
in response to receiving a search request from a user, obtaining a search intent of the user based on the search request;
determining, based on the search intent, a primary search system and a secondary search system from a natural language model-based search system and a search engine-based search system, respectively; and
in a search result for the search request, presenting a primary result matched to the search request from the primary search system and a secondary result matched to the search request from the secondary search system with different display attributes, respectively.
